(19) United States
(12) Patent Application Publication
(10) Pub. No.: US 2024/0015039 A1
(43) Pub. Date: Jan. 11, 2024

(54) METHOD FOR MANAGING A REQUEST TO ACCESS A LOCAL COMMUNICATION NETWORK, METHOD FOR PROCESSING A REQUEST TO ACCESS A LOCAL COMMUNICATION NETWORK, METHOD FOR REQUESTING ACCESS TO A LOCAL COMMUNICATION NETWORK AND CORRESPONDING DEVICES, MANAGEMENT PLATFORM, GATEWAY, USER TERMINAL, SYSTEM AND COMPUTER PROGRAMS

(71) Applicant: Orange SA, Issy-Les-Moulineaux (FR)

(72) Inventors: Philippe DUSSAUME, Chatillon Cedex (FR); Jean Philippe JAVAUDIN, Chatillon Cedex (FR)

(21) Appl. No.: 18/255,841

(22) PCT Filed: Dec. 2, 2021
(86) PCT No.: PCT/FR2021/052193

§ 371 Date: Jun. 2, 2023

(30) Foreign Application Priority Data
Dec. 4, 2020 (FR) 2012733

(51) Int. Cl. H04L 12/12; H04L 12/66; H04L 9/40

(52) U.S. Cl. CPC H04L 12/12; H04L 12/66; H04L 63/10; H04L 63/0807

(57) ABSTRACT

A method for managing a request to access remotely a local communication network managed by a gateway to access a remote communication network. The method is implemented by a management platform connected to the remote network and includes: receiving the request to access the local communication network from a user terminal connected to the remote communication network, the request including at least one user identifier; verifying an authorization of the user to access the network using the user identifier and access rights stored in memory; and if the user is authorized to access the requested network, transmitting a wake-up message to the gateway; and transmitting to the user terminal a response including at least one identifier of the gateway.

### CROSS-REFERENCE TO RELATED APPLICATIONS

This application is filed under 35 U.S.C. § 371 as the U.S. National Phase of Application No. PCT/FR2021/052193 entitled “METHOD FOR MANAGING REQUESTS TO ACCESS A LOCAL COMMUNICATION NETWORK, METHOD FOR PROCESSING SUCH REQUESTS, METHOD FOR REQUESTING ACCESS TO A LOCAL COMMUNICATION NETWORK, AND CORRESPONDING DEVICES, MANAGEMENT PLATFORM, GATEWAY, USER TERMINAL, SYSTEM AND COMPUTER PROGRAMS” and filed Dec. 2, 2021, and which claims priority to FR 2012733 filed Dec. 4, 2020, each of which is incorporated by reference in its entirety.

### BACKGROUND

### Technical Field

The field of the development is that of a home or office local communication network, managed by a gateway, to which user equipment are connected, the gateway and the equipment are configured to go into a standby state when not in use.

In particular, the development relates to remote access to this local network by a user and waking up the gateway and equipment of this network, when the user is allowed to access them.

### Prior Art

While the Internet of Things tends to impact all aspects of daily and professional life, citizens are increasingly concerned about the future of the planet. This concern leads them to reduce the waste of energy resources.

In the connected home or office, energy consumption can be reduced by stopping or placing in a standby state equipment that is not in use, or at least some of its components, applications or interfaces. This is the case, for example, when the inhabitants of a house are away on holiday. Today, a group of items of equipment can be remotely stopped and restarted using a common power socket with a 3G/4G control interface.

However, it is still difficult to achieve flexible management and use of this equipment by this means. In any case, this management cannot be automated.

In order to allow equipment to remain in a standby state but to be woken up at any time, either at the request of a user or automatically, it is also known, on Ethernet networks, to send a wake-up packet to the IP address of the gateway that manages the local communication network, this packet mentioning the MAC address of the item of equipment to be woken up.

Yet, although appealing, this solution poses a real security problem and the absence of the inhabitants of the house or members of the company's premises gives hackers free rein to try to wake up the equipment connected to the local communication network and the communication interfaces of the local network to gain remote access, either by brute force or by denial of service.

It is understood that, without a secure solution for waking up their equipment remotely when they need it, users have no choice but to leave their equipment running while they are away or to forego remote access, thus avoiding energy waste.

The development improves the situation.

### SUMMARY

The development responds to this need by proposing a method for managing a request to access a service operated by a local communication network managed by a gateway to access a remote communication network.

Said method is implemented by a management platform connected to the remote network and comprises:
receiving said request to access a local communication network from a user terminal connected to the remote communication network, said request comprising at least one user identifier;
verifying that the user is authorised to access said network using said user identifier and access rights stored in memory; and
if the user is authorised to access the requested network, transmitting a wake-up message to the gateway;
transmitting to the user terminal a response comprising at least one identifier of said gateway.

The development proposes a completely new and inventive approach to solving the problem of remote access to a local communication network by a user terminal. This approach consists in delegating the task of authorising or prohibiting access to the network requested by the user to a platform managed by the remote network operator. The latter is therefore responsible for verifying upstream that the user requesting access to the local network is authorised to do so, before actually waking up the gateway, when the gateway that manages this network is in a standby state. When the gateway is active, the wake-up message is simply treated as a request to access the local network controlled by the management platform.

In this way, the remote network operator controls and secures access to the local communication network by a user.

In addition, remote access to a service operated by the local network is made easier for the user who always contacts the same interlocutor, the platform, and does not need to memorise the identification information of the gateway.

For example, the user subscribed to a service for managing remote access to the local communication network managed by their home gateway. They access it via an application installed on their terminal, a web application or a web page, whose human/machine interface allows them to submit their access request.

Thus, the development allows the user to reconcile comfort of use, energy savings and computer security.

According to an aspect of the development, the method comprises transmitting to the user terminal a request to select a local network and the transmission of the wake-up message is triggered upon receipt of a response comprising the identifier of the selected local communication network to the gateway that manages the selected local communication network.

When the human/machine interface available on the user terminal to communicate with the management platform is simple and does not allow the user to choose the local network they want to access, or when the user requests access to a local network for which they do not have an access authorisation, the platform advantageously offers this choice to the user.

When the human/machine interface of the user terminal is more elaborate and proposes that the user select a local network from a plurality of authorised local networks, then the access request further comprises the identifier of the selected local network and the verification of an authorisation of the user's rights consists in, at the management platform, searching for this local network identifier in the access rights associated with the user identifier.

According to another aspect of the development, the method comprises, following the transmission of the wake-up message, receiving a validation of an authorisation to access the service from the gateway and the response is transmitted to the user terminal, following said reception.

With the development, the upstream filtering is stricter. In this way, the gateway only receives connection requests from user terminals for which it has validated the authorisation granted by the platform.

According to yet another aspect of the development, the validation of an access authorisation received from the gateway comprises an access authorisation token and the response transmitted to the user terminal comprises said token.

Since it has been validated by the gateway in response to the validation request of the platform, the access authorisation token constitutes a correlation link between the access authorisation it has granted to the management platform and the request to connect to its network that it then receives from the user terminal. One advantage is that it makes it easier to control connection requests at the gateway.

Advantageously, the gateway generates this authorisation token. According to a variant, the authorisation token is generated by the platform and transmitted to the gateway in a request to validate an access authorisation of the user. The gateway reinserts it in the validation response. One advantage of this variant is that on the one hand, the platform has a CPU capacity that is generally greater than that of the gateway and on the other hand, it is legitimate to support this generation because it ensures the security of access to the gateway.

In yet another variant, the access authorisation token is generated by the user terminal that transmits it to the management platform in its request to access the local network.

The development also relates to a computer program product comprising program code instructions for implementing a management method according to the development, as described previously, when it is executed by a processor.

The development also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be streamed in particular on a network, for example the Internet network.

Alternatively, the storage medium can be an integrated circuit in which the program is embedded, the circuit being adapted to execute or to be used in the execution of the above-mentioned management method.

The development also relates to a device for managing a request to remotely access a local communication network managed by a gateway to access a remote communication network. Said device is configured to implement at a management platform connected to the remote network:
receiving said request to access a local communication network from a user terminal connected to the remote communication network, said request comprising at least one user identifier;
verifying an authorisation of the user to access said network using said user identifier and access rights stored in memory; and
if the user is authorised to access the requested network,
transmitting a wake-up message to the gateway;
transmitting to the user terminal a response comprising at least one identifier of said gateway.

Advantageously, said device is configured to implement the above-mentioned access request management method, according to its different embodiments.

Advantageously, said device is integrated into a management platform, said platform being connected to the remote communication network.

The above-mentioned corresponding management platform, management device and computer program have at least the same advantages as those provided by the above-mentioned management method according to the different embodiments of the present development.

Correlatively, the development also relates to a method for processing a request to remotely access a local communication network managed by a gateway to access a remote network. Such a method is implemented by said gateway and comprises:
receiving a wake-up message from a management platform connected to the remote network, said platform being configured to receive a request to access a local communication network from a user terminal connected to the remote network and to verify an authorisation of said terminal to access said network;
when the gateway is in a standby state, triggering a gateway wake-up operation, and
upon receipt of a request to validate an authorisation of the user to access the local network from the management platform, transmitting a response to validate the authorisation of the user to access the local network to said management platform; and
upon receipt of a connection request from the user terminal, connecting the user terminal to the local network.

With the development, the WAN interface of the gateway that manages the local network only processes wake-up messages from the management platform set up by the remote network operator.

As this platform has already filtered the access requests upstream, it only has to validate the authorisations submitted by the platform.

According to an aspect of the development, said method comprises obtaining a connection authorisation token and the access authorisation validation response comprises said token.

For the access requests it validates, the gateway obtains an access authorisation token it transmits to the management platform. This token is intended to be inserted by the user terminal in its connection request as it allows the gateway to establish a correlation link easily with the authorisation it has validated at the request of the platform. It obtains this token either by generating it itself or by receiving it from the platform in its validation request.

According to another aspect of the development, the method comprises obtaining wake-up constraints comprising authorised time periods and prohibited time periods and verifying that waking up the gateway in the current time period is authorised.

One advantage is that it allows the administrator of the local network to define time periods when remote wake-up of the local network is prohibited.

The development also relates to a computer program product comprising program code instructions for implementing a processing method according to the development, as described previously, when it is executed by a processor.

The development also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be streamed in particular on a network, for example the Internet network.

Alternatively, the storage medium can be an integrated circuit in which the program is embedded, the circuit being adapted to execute or to be used in the execution of the above-mentioned processing method.

The development also relates to a device for processing a request to remotely access a local communication network managed by a gateway to access a remote network.

Such a device is configured to implement at the gateway:
receiving a wake-up message from a management platform connected to the remote network, said platform being configured to receive a request to access a service operated by said local communication network from a user terminal connected to the remote network and to verify an authorisation of said terminal to access said service;
when the gateway is in a standby state, triggering a gateway wake-up operation, and
upon receipt of the user's access rights to the service from the management platform, validating the user terminal's authorisation to access the service and transmitting a validation response to said management platform; and
upon receipt of a connection request from the user terminal comprising at least the gateway identifier, connecting the user terminal to the local network.

Advantageously, said device is configured to implement the above-mentioned access request processing method, according to its different embodiments.

Advantageously, said device is integrated into a gateway to access a remote communication network, configured to manage a local communication network.

The above-mentioned corresponding gateway, processing device and computer program have at least the same advantages as those provided by the above-mentioned processing method according to the different embodiments of the present development.

Correlatively, the development also relates to a method for requesting remote access to a local communication network managed by a gateway to access a remote communication network by a user terminal connected to the remote network.

Said method is implemented by the user terminal and comprises:
transmitting a request to access a local communication network to a management platform connected to the remote network, said request comprising at least one user identifier;
receiving a response from said platform comprising at least one identifier of said gateway;
transmitting a connection request to said IP address.

With the development, the user terminal only needs to know the address of the management platform and to have access rights to the local network stored in this platform in order to access the local network.

According to an aspect of the development, the response further comprises an access authorisation token to the network and the connection request comprises said token.

This token constitutes a correlation link between the access authorisation validation requested by the platform and granted by the gateway and the connection request to the gateway transmitted by the user terminal. It facilitates and secures the control of connection requests received by the gateway. This token can be generated by the gateway or by the management platform or even by the terminal. If applicable, it transmits it to the platform via its request to access the local network.

According to another aspect of the development, the method further comprises a selection of a local network from a plurality of authorised local networks, upon receipt of a selection request received from the management platform or the user terminal.

One advantage is that it allows the user to easily choose a local network without having to memorise the ID of the gateway that manages it. This selection may be offered to them when they do not specify which local network they want to access or when their access request comprises an identifier of a local network they are not authorised to access.

According to a first example, the human/machine interface available on the terminal is simple and only allows a connection to the management platform. In this case, the platform asks the user to select a network and/or an item of equipment and/or a service from those for which they have an authorisation.

According to a second example, the human/machine interface available from the user terminal allows the user to locally select the network they want to access. For example, a menu is proposed to the user. In this case, the access request transmitted by the terminal comprises the identifier of the requested network.

The development also relates to a computer program product comprising program code instructions for implementing a method for requesting access to a local network according to the development, as described previously, when it is executed by a processor.

The development also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be streamed in particular on a network, for example the Internet network.

Alternatively, the storage medium can be an integrated circuit in which the program is embedded, the circuit being adapted to execute or to be used in the execution of the above-mentioned access request method.

The development also relates to a device for requesting remote access to a local communication network managed by a gateway to access a remote communication network by a user terminal connected to the remote network.

Said device is configured to implement at the user terminal:
transmitting a request to access a local communication network to a management platform connected to the remote network, said request comprising at least one user identifier;
receiving a response from said platform comprising at least one identifier of said gateway; and transmitting a connection request to said gateway using said identifier.

Advantageously, said device is configured to implement the above-mentioned access request method, according to its different embodiments.

Advantageously, said device is integrated into a user terminal connected to the remote network. The above-mentioned corresponding terminal, access request device and computer program have at least the same advantages as those provided by the above-mentioned access request method according to the different embodiments of the present development.

Finally, the development relates to a system for managing remote access to a local communication network managed by a gateway to access a remote network.

Said system comprises the above-mentioned gateway, management platform and user terminal.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1: shows an example of the architecture of a system for managing remote access to a local communication network according to the development;

FIG. 2: diagrammatically illustrates examples of the architecture of a management platform integrating a device for managing a request to remotely access a service according to an embodiment of the development, a gateway to access the remote network configured to manage the local network and a user terminal requesting remote access according to an embodiment of the development;

FIG. 3: describes in the form of a flowchart the steps of a method for managing a request to remotely access a local communication network according to an embodiment of the development;

FIG. 4: describes in the form of a flowchart the steps of a method for processing a request to remotely access a local communication network according to an embodiment of the development;

FIG. 5: describes in the form of a flowchart the steps of a method for requesting remote access to a local communication network according to an embodiment of the development;

FIG. 6: describes in the form of a flow diagram the exchanges between the user terminal, the management platform and the gateway to access the local communication network according to a first embodiment of the development;

FIG. 7: describes in the form of a flow diagram the exchanges between the user terminal, the management platform and the gateway to access the local communication network according to a second embodiment of the development;

FIG. 8: describes an example of a hardware structure of a device for managing a request to access a local communication network according to the development;

FIG. 9: describes an example of a hardware structure of a device for processing a request to access a local communication network according to the development; and

FIG. 10: describes an example of a hardware structure of a device for requesting access to a local communication network according to the development.

### DETAILED DESCRIPTION OF CERTAIN EMBODIMENTS

The general principle of the development is based on the implementation of a management platform in a remote communication network, that manages all requests to access the local communication network of a gateway to access the remote network from a user terminal connected to this remote network. To do this, it receives the request to access a local communication network, verifies that the user is authorised to access this local network, wakes up the gateway that manages this local network if applicable, has this access authorisation validated by the gateway and redirects this validation to the user terminal. With the connection information received from the platform, the user terminal can then connect to the gateway and access the requested service. It can then ask the gateway to access an item of equipment/service of the local network.

This development has many applications in both everyday and professional life, for any type of user terminal, such as a smartphone, a tablet, a laptop, etc., that is connected to a telecommunication network WAN (Wide Access Network) and wants to remotely access services of a local communication network LAN (Local Access Network) in its personal or professional environment.

In particular, this development is particularly interesting when the gateway that manages it is in a standby state.

In the remainder of the description, a service operated in the local communication network is defined in the broadest sense as one or more functions executed by one or more items of equipment connected to this network. Examples include remote access to a photo album stored in a network-attached storage server NAS connected to a user's home network. A service can also comprise a more complex sequence of functions defined by a program or script, and require different resources or items of equipment to cooperate. This is the case, for example, of a presence simulation service involving several items of equipment of the local network, or a local video broadcasting service whose implementation relies on the cooperation of storage, communication in the local network and video broadcasting resources (set-top box/screen).

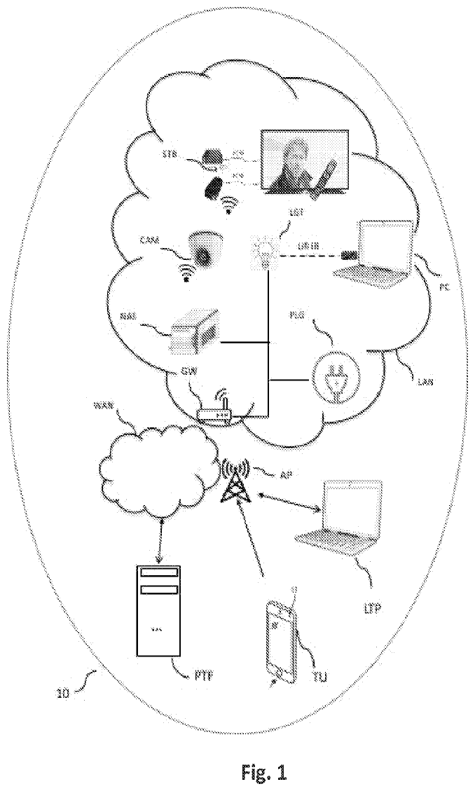

In relation to FIG. 1, an example of the architecture of a system for managing 10 a request to access a communication network LAN by a user terminal TU connected to a remote communication network WAN of an operator according to an embodiment of the development is now presented. The communication network LAN is managed by a gateway GW to access the remote network WAN provided by the operator to a user who has subscribed to that operator. In the example considered, the gateway is connected to the remote network WAN via an ADSL or fibre link. Of course, it can also connect to the operator's cellular network via a 2G to 5G link.

In this example, the network LAN is a home network, to which several items of equipment are connected, such as a camera CAM, a network-attached storage server or NAS, a set-top box STB, or even a connected plug PLG, a connected lamp LGT and a personal computer PC. These items of equipment are connected to the gateway GW. For example, the storage server NAS, the connected lamp LGT and the connected plug PLG are connected to the gateway GW via a wired link, for example Ethernet, USB or PLC over electrical wiring, the set-top box STB and the camera CAM are connected via a wireless radio link, for example Wi-Fi, and the personal computer PC is connected through the connected lamp LTG via a Li-Fi optical wireless link. Naturally, other types of wireless links can be used such as Bluetooth, Bluetooth Low Energy, z-wave, zigbee, DECT-ULE, etc.

Terminals such as the smartphone TU or the laptop LTP of at least one user U authorised to connect to the local network LAN but which are, in the example of FIG. 1, not in the house and connected to the remote network WAN, are also considered.

For example, it is assumed that the user is away from home and has gone to a holiday resort for several days. It is also assumed that the user who administers the gateway and the home local network LAN, who may or may not be the user U, has placed at least one part of the items of equipment of that network in a standby state. For example, they have activated the “Extended Absence” use scenario on a service administration portal of their home gateway GW offered by their operator. For example, this portal is accessible from a mobile application installed on their telephone TU or a web application accessible from a web browser on their laptop LTP. The explicit switch to this use scenario induces for example:
sending commands to cut off the power supply to the connected electrical outlets that serve the items of equipment considered as non-essential, either explicitly predefined or by default,
sending standby commands (ad hoc Ethernet packet) to the items of equipment likely to be woken up during this period, either on demand or by fixed or semi-random programming (presence simulation), such as STBs, TV sets, connected lamps,
saving in non-volatile memory on their gateway the IP and MAC addresses of the items of equipment placed in a standby state, or if applicable, their unique identifier on the networks,
sending commands to activate equipment dedicated to presence detection and alarms such as a central alarm station (not shown) and some stand-alone cameras,
stopping unnecessary and energy-consuming interfaces on the gateway, such as Wi-Fi or 4G/5G where applicable, and maintaining others, such as BLE and Ethernet,
stopping unnecessary and energy-consuming applications on the home gateway,
activating a program on the gateway that manages a presence simulation calendar with communication of its programming to the central alarm station, so that its light or suspicious noise detection system is not disturbed,
activating a program on the gateway that manages a standby and wake-up calendar for certain interfaces of the gateway, such as its Wi-Fi interface (ad hoc Ethernet packet).

Switching some items of equipment to standby or monitoring mode (for example, the stand-alone camera) induces in these:
maintaining the Bluetooth Low Energy (BLE) interfaces on the items of equipment that have some,
maintaining the Ethernet interfaces on the items of equipment that have some,
placing in a standby state or stopping the Wi-Fi interfaces of the items of that also have a Bluetooth Low Energy (BLE) or Ethernet interface,
stopping some of their components and embedded applications,
monitoring by them of wake-up messages on their BLE and Ethernet interfaces.

It is assumed now that the user of the local network LAN wants to remotely access this local network LAN, from their terminal TU connected to the remote network WAN, while the gateway GW that manages it is in a standby state. For example, they want to access the network LAN to view on their terminal TU a photo album stored in the storage server NAS.

As illustrated in FIG. 1, the system 10 according to the development comprises a management platform PTF managed by the operator of the remote network WAN and connected to this network. This platform is configured to receive and manage a request to remotely access a service of the network LAN transmitted by the user terminal. The system 10 also comprises the gateway GW configured to manage the local network LAN and to route communications from the user terminals connected to the network LAN to the remote network WAN. Finally, the system 10 comprises the user terminal TU.

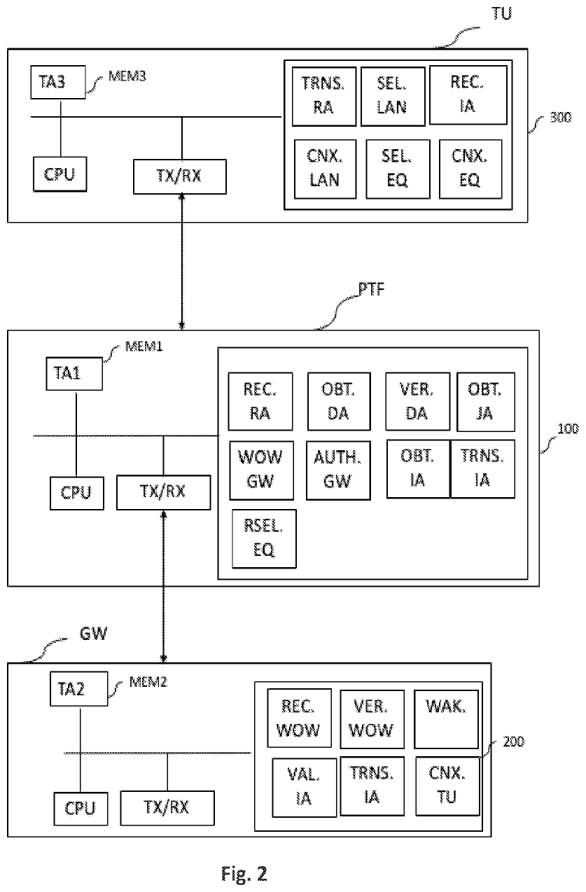

FIG. 2 shows an example of the architecture of the management platform PTF according to an embodiment of the development. According to this embodiment of the development, the platform PTF comprises a device 100 for managing a request to remotely access the local network LAN according to the development, configured to receive this remote access request from the user terminal TU, verify it is authorised to access the requested local network LAN using access rights previously stored in memory, if necessary wake up the domestic gateway GW, obtain an access authorisation validation and redirect it to the user terminal.

Access rights are for example stored in a table TA1 in association with an identifier of the user IDU or their terminal in a local or remote memory MEM, for example organised as a database, which can be accessed by the platform PTF.

Alternatively, the device 100 may be independent of the management platform PTF, but connected to it by any link whatsoever, wired or not.

In particular, the management device 100 comprises a module REC. RA for receiving a request to access a local network from the user terminal TU, the request comprising at least one user identifier IDU, a module VER. DA for verifying an authorisation of the user to access the requested network, a module WOW GW for waking up the gateway, configured to be implemented when the user is authorised to access the network, a module OBT. IA for obtaining an authorisation validation from the gateway, and a module TRNS. IA for transmitting to the user terminal TU connection information to the gateway.

It is noted that the verification can apply to the terminal, the user, or both:
any user of a given terminal can be implicitly authorised (the user identifier is that of the terminal or the application instance in charge of the usage session),
a given user can be authorised on any terminal (the authorised user ID is specific to that user or to a group of users),
a given user can be authorised on a given terminal (double check: user ID and terminal identifier).

Advantageously, the device 100 further comprises a module AUTH for authenticating the management platform to the gateway GW. It can also comprise a module for requesting the selection of a local network RSEL to the user terminal from a plurality of authorised local networks and a module for obtaining SEL the local network selected by the user terminal from the plurality transmitted. It can also comprise a module OBT. JA for obtaining an access authorisation token to the gateway, said token being intended to be transmitted to the user terminal in the gateway connection authorisation information.

Finally, the device 100 comprises a module TX/RX for receiving and transmitting information via the remote network WAN. Alternatively, it uses the transmission/reception module of the platform PTF into which it is integrated.

The non-volatile memory MEM1 advantageously comprises a table TA1 associating with a user identifier access rights to one or more local communication networks LAN and to equipment/services of this network.

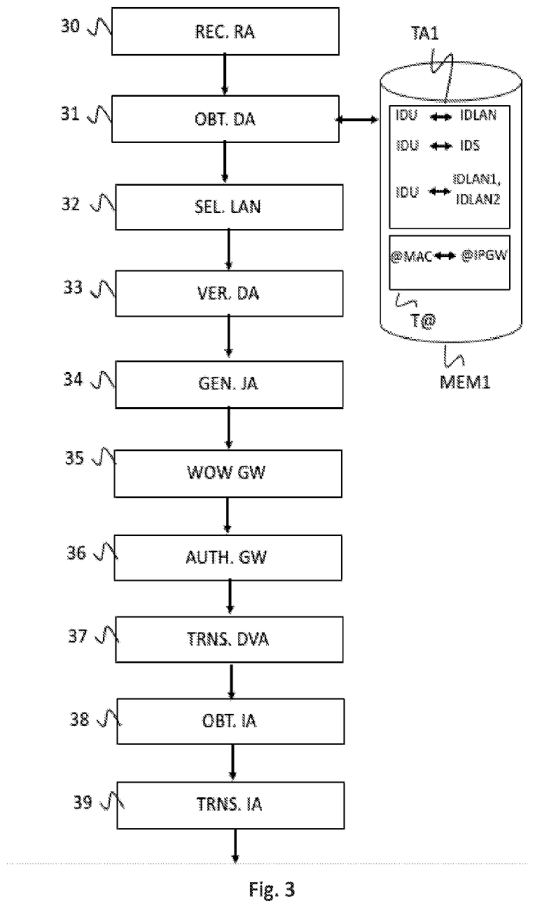

The device 100 thus implements the method for managing a request to remotely access a local communication network according to the development that will be detailed hereafter in relation to FIG. 3.

FIG. 2 also shows an example of the architecture of a gateway GW according to an embodiment of the development. According to this embodiment of the development, the gateway GW comprises a device 200 for processing a remote access request transmitted by a user terminal, to a local network LAN according to the development, configured to receive a wake-up message from the platform PTF, if necessary wake up, validate an authorisation request to access the service from the platform and transmit to it a validation response comprising connection information to the gateway and, upon receipt of a connection request from the user terminal, process its request favourably when it comprises said connection information.

Alternatively, the device 200 may be independent of the gateway GW, but connected to it by any link whatsoever, wired or not.

In particular, the processing device 200 comprises a module REC. WOW for receiving a wake-up message from the management platform PTF, a module VAL. IA for validating an authorisation request to access the service from the management platform PTF and transmitting to said management platform a validation response TRNS. IA comprising connection information to the gateway. The device 200 also comprises a module for connecting the user terminal to the service upon receipt of a connection request comprising the connection information to said gateway.

Advantageously, the device 200 also comprises a module AUTH PTF for authenticating the management platform PTF and a module RSEL EQ for transmitting to the user terminal a request to select an item of equipment/service from a plurality of items of equipment/services the user is authorised to access. It can comprise a module JA for obtaining an access authorisation token, said token then being inserted in the validation response to the platform with the connection information. This token can be generated by the gateway itself or received from the platform.

Advantageously, the device 200 finally comprises a module TX/RX for receiving and transmitting information via an interface with the remote network WAN and another interface with the local communication network LAN. Alternatively, it uses the transmission/reception module of the gateway GW into which it is integrated.

The non-volatile memory MEM2 advantageously comprises a table TA2 associating with a user identifier access rights to the local communication network LAN and to equipment/services of this network.

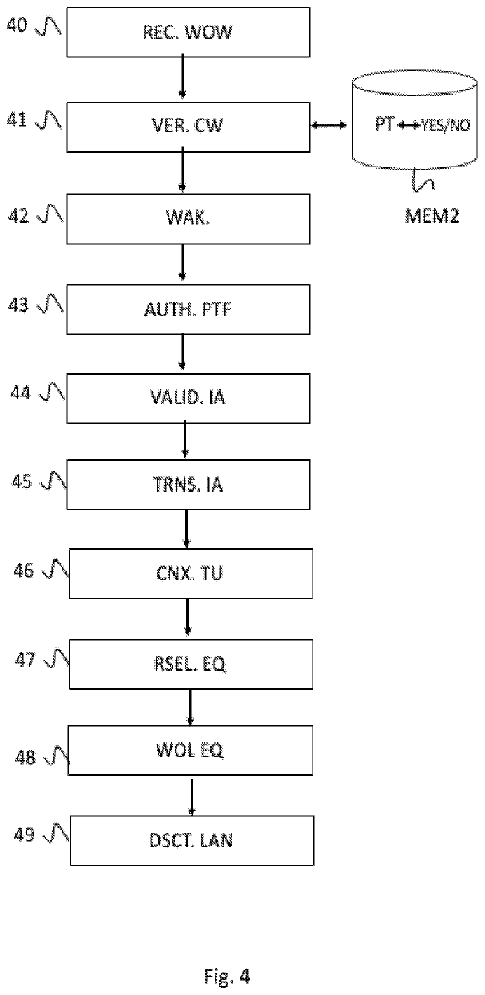

The device 200 thus implements the method for processing a request to remotely access a local network according to the development that will be detailed hereafter in relation to FIG. 4.

Finally, FIG. 2 shows example of the architecture of a user terminal TU according to an embodiment of the development. According to this embodiment of the development, the user terminal TU comprises a device 300 for requesting remote access to a local network LAN, configured to transmit a request to access such a network to the PTF platform, receive connection information to the gateway from the platform PTF and transmit a connection request comprising the connection information to the PTF platform.

Alternatively, the device 300 may be independent of the user terminal TU, but connected to it by any link whatsoever, wired or not.

In particular, the access request device 300 comprises a module TRNS RA for transmitting a request to access a local communication network LAN to the platform PTF, a module REC. IA for receiving connection information to the gateway GW and a module CNX for requesting a connection to the IP address of the gateway, the connection request comprising the received connection information. Advantageously, this information comprises an access authorisation token to the gateway.

Advantageously, the device 300 also comprises a module SEL. LAN for selecting a local network from a plurality of local networks authorised by the platform for the user terminal, and a module SEL. S for selecting an item of equipment/service from a plurality of items of equipment/services authorised by the gateway for the user terminal. It can also comprise a module for generating the access authorisation token to the gateway, said token being transmitted in its request to access the local network transmitted to the platform PTF.

Advantageously, the device 300 finally comprises a module TX/RX for receiving and transmitting information via an interface with the remote network WAN and another interface with the local communication network LAN. Alternatively, it uses the transmission/reception module of the user terminal TU into which it is integrated.

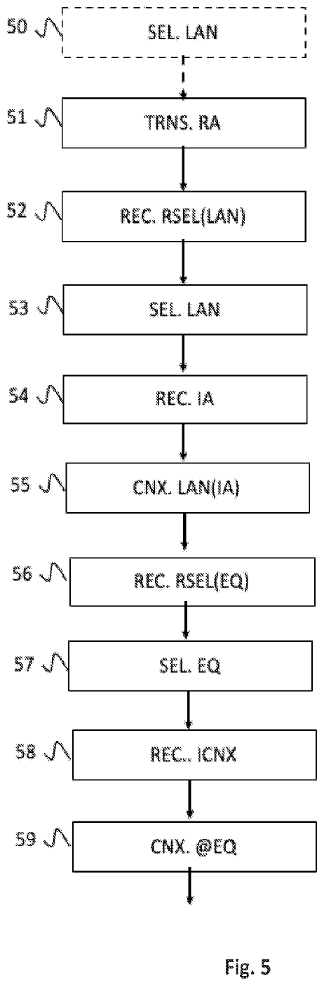

The device 300 thus implements the method for requesting remote access to a service according to the development that will be detailed hereafter in relation to FIG. 5.

In relation to FIG. 3, a first embodiment of a method for managing a request to access a local communication network LAN managed by the gateway GW to access the remote network WAN, from the user terminal TU, when the gateway GW is in a standby state, according to an embodiment of the development, is now presented in the form of a flowchart.

In a step 30, the management gateway PTF, connected to the remote network WAN, receives the request RA to access a local network LAN from the user terminal TU. This request RA comprises at least one user identifier IDU of the user of the terminal TU.

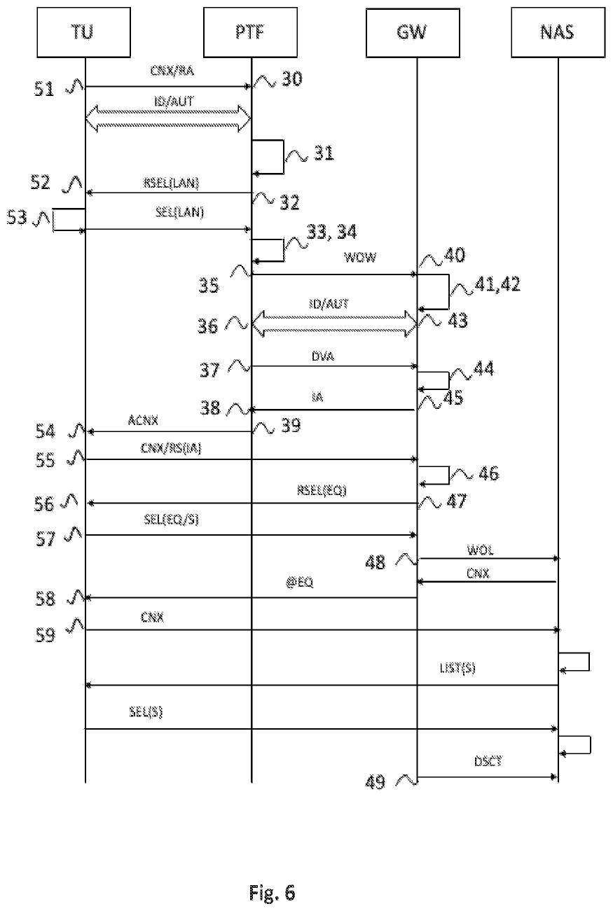

Advantageously, it also comprises an identifier of the local network IDLAN that operates the service and/or an identifier of the gateway IDGW that manages the local network LAN and/or an identifier of an item of equipment or service IDS that the user wants to access remotely. For example, the user subscribed to a service for managing remote access to the local communication network managed by their home gateway, offered by the remote network operator. They access it for example via a software application installed on their terminal or a web application or even a web page, whose human/machine interface allows them to submit their access request. It is understood that the quantity of information contained in this access request RA depends in particular on a level of intelligence of the human/machine interface and on the information relating to the user's access rights available to it. At a minimum, it has the unique identifier of the management platform PTF in the remote network WAN to which the access request RA is to be transmitted, but if its interface is more advanced, it can propose that the user choose a local network from a plurality of local networks for which they have an access authorisation, and even the services operated by these networks. In this case, it stores this information in memory, for example in a table or a database. It is recalled that the term service refers here in the broadest sense to any functionality made available to a user by one or more resources of a local communication network. Examples include the Wi-Fi interface of the gateway or a presence simulation service that involves several resources of the local network (camera, NAS storage server, Wi-Fi interface, etc.). Some embodiments will be detailed hereafter in relation to FIGS. 6 and 7.

In 31, the device 100 obtains information DA relating to the user's access rights, for example associated in a memory MEM1 with the user identifier IDU contained in their request RA. For example, it queries a database TLAN based on the identifier IDU and obtains in return one or more identifiers, also called labels, of gateways or local services to which the user is authorised to connect. It is understood that a user can be authorised to access several local networks, for example their home network managed by their home gateway and one or more office local networks. It can also be considered that several local network tags are stored in association with a site tag IDS, a site corresponding to an office or home location that contains several local networks.

Optionally, in 32, the device 100 transmits a request to select a local network to the user terminal, comprising the identifiers of the authorised local networks. Advantageously, it implements this step when the access request does not comprise a local network or gateway identifier, for example a MAC address or a unique identifier, or when the user has requested access to a local network for which they are not authorised while at least
one authorised local network identifier is associated with the user identifier IDU in the table. A unique identifier is a future identifier considered to replace MAC addresses at the link layer. Today, an item of equipment with Wi-Fi interfaces on different frequency bands has a different MAC address for each of them. This could be useless with such a unique identifier.

Upon receipt of a response, comprising a local network identifier IDLAN, the device 100 verifies in 33 that the user is authorised to access the local area network LAN received in 30 or 33 based on the access rights obtained.

If necessary, it transmits in 35 a wake-up message WOW to the gateway GW that manages the requested local network LAN. To do this, the device 100 has previously obtained an IP address of the gateway for example from a second routing table T@ in association with the MAC address of that gateway. This IP address is maintained in the platform using a static IP address/gateway MAC address of the gateway association stored in a routing table. In this respect, it is noted that the IP address of a gateway can be fixed, preferred or dynamic. It is assumed that the user as a client of the service for remotely accessing their local network has a fixed or preferred address for their gateway. In case this address is changed after a certain number of days of inactivity, the platform would only need to periodically wake up the gateway and then send it a standby application message to maintain its address table.

Alternatively, it can be decided to assign a fixed IP address to the gateways of users subscribing to the service.

For example, the wake-up message is a “Wake on Wan” message, known to those skilled in the art, encapsulated in an IP packet. This wake-up packet is transmitted, for example using the UDP (User Datagram Protocol) protocol, to the gateway GW by the network WAN, regardless of the technology used, such as ADSL or fibre, and passes through an item of access equipment of type DSLAM (Digital Subscriber Line Access Multiplexer) for the former or ONT (Optical Network Termination) for the latter.

In 36, the device 100 receives an authentication request from the gateway GW. It responds to it by implementing an encrypted mutual authentication exchange between the gateway and the platform, according to a procedure known to those skilled in the art.

In 37, the device 100 transmits to the gateway a validation request DVA for the access authorisation to the requested local network it has granted to the user, for validation. This request comprises the access rights (or credentials) obtained in memory for this local network in association with the user identifier IDU. Examples include the login/password information, possibly an encryption key. In a favourable case, it receives in 38 an authorisation validation response comprising the connection information. Advantageously, the response further comprises an access authorisation token JA generated by the gateway. According to an alternative, the validation request DVA transmitted by the device 100 to the gateway GW comprises a temporary authorisation token JAT that is returned as a validated authorisation token JA by the gateway to the platform. According to another alternative, the temporary token has been received from the user terminal in its access request DA and inserted in the connection information of the validation request sent by the platform PTF to the gateway GW.

In 39, the device 100 redirects the connection information received in the validation response from the gateway to the user terminal TU.

In relation to FIG. 4, an embodiment of a method for processing a request to access a local communication network LAN managed by the gateway GW to access the remote network WAN, from the user terminal TU, according to an embodiment of the development, is now presented in the form of a flowchart. For example, this method is implemented by the device 200.

It is assumed that the gateway GW is in a standby state.

In 40, the device 200 receives a wake-up message WOW from the management platform PTF on its interface of the remote network WAN.

In 41, it optionally verifies that waking up the gateway GW is authorised. For example, the device 200 obtains information relating to wake-up constraints stored in memory. It consists for example in time constraints recorded in a calendar table, that associates a wake-up authorisation or prohibition with a particular time period. In this case, the period can be expressed in hours or days. The verification consists in this case in verifying that the current day/date/time belongs to an authorised period. According to an embodiment, to do so, the device 200 orders a driver of the WAN interface of the gateway to trigger an appointment management program.

If waking up the gateway is prohibited in the current period, for example, outside working hours or days for a corporate gateway or during scheduled sleeping hours at the holiday location for a home gateway, the device 200 transmits a negative response to the platform.

It is now assumed that waking up the gateway is authorised. The device 200 orders in 42 the execution of a gateway wake-up operation.

In 43, the device 200 transmits to the platform an authentication request and implements, upon receipt of a response from the platform, a mutual authentication procedure, involving encrypted exchanges. As this procedure is known to those skilled in the art, it is not detailed.

In 44, once the authentication is complete, the device 200 verifies the access authorization granted by the platform, received in a validation request DVA from the platform and from access rights stored in memory in association with a user identifier IDU.

If it validates this authorisation, it transmits in 45 to the management platform PTF a validation message VA comprising connection information IA. Advantageously, it obtains an access authorisation token JA, that has for example been generated by the gateway or by a dedicated module of the local network. It stores this token JA in memory in association with the user identifier. According to an alternative, this authorisation token has not been generated by the gateway, but corresponds to a temporary authorisation token JAT received from the management platform PTF in its validation request DVA.

In 46, upon receipt of a connection request from the user terminal TU, the connection request comprising the connection information, the gateway verifies that this connection information corresponds to the one it has validated in the request received from the platform. Advantageously, this information comprises the access authorisation token JA and it verifies that the access authorisation token received corresponds to the one it has transmitted in response to the validation request DVA from the platform. If necessary, it establishes a connection with the user terminal TU.

Once the connection has been established with the user terminal TU, the gateway offers it in 47 a choice of items of equipment and/or services rendered by these items of equipment the user is authorised to access, such as the gateway itself, the NAS storage server, the camera, the laptop, a home automation base, etc. Depending on the choice received from the user, it wakes up in 48 the selected item of equipment. As this item of equipment is not integrated into the gateway, it retrieves in a non-volatile memory the connection information to this item of equipment and its different communication interfaces in the network LAN, and then sends it a wake-up packet on a communication interface that remained active. For example, if the item of equipment is connected via Ethernet, it sends it a “Wake on LAN” wake-up packet, in a manner known to those skilled in the art. Finally, it transmits its IP address @EQ to the user terminal TU so that it can connect to the requested item of equipment.

It is noted that if the gateway is not in a standby state when it receives the wake-up message WOW from the platform PTF, it treats it as a signal to warn it that it will receive a request to validate an authorisation of a user terminal to access its local network LAN from the platform PTF.

In relation to FIG. 5, an embodiment of the method for requesting access by a user terminal to a local communication network managed by a gateway to access a remote network according to an embodiment of the development is now presented in the form of a flowchart. In this example, the method is implemented by the device 300.

Advantageously, this device 300 is integrated into the user terminal TU.

In a step 51, the device 300 transmits a request RA to access a local communication network, for example the local network LAN managed by the gateway GW of FIG. 1. This request RA comprises at least one identifier IDU of the user of the terminal TU. As previously mentioned, the user submits their request to access the local network LAN via a human/machine interface of their terminal, for example an application implemented by the terminal or a web application. This application can have information relating to the local networks the user has already accessed or is authorised to access and offer them to easily select the network they are interested in. For example, it accesses a table TA3 associating access rights with the user identifier IDU.

It is understood indeed that a user who is not connected to their local network does not necessarily know the IP address nor the unique identifier of the gateway that manages the local network in question, or even the identifier of that network. In this case, it is assumed that the user has selected in 50 the local network LAN they want to access, for example in a menu of the interface of their terminal TU.

This application can also have a quantity of information limited to the IP address of the management platform PTF to be contacted. In this case, the request RA is a simple request to connect to the management platform PTF.

Optionally, in 52, the device 300 receives a request to select a local network LAN from the platform, the request comprising at least two identifiers of networks LAN the user is allowed to access. It selects in 53 the identifier of the network LAN it is interested in and transmits it to the platform.

In 54, it receives connection information from the platform. It comprises at least the gateway GW identifier and for example a login identifier and a password of the user. It can also comprise an access authorisation token JA. For example, this token has been generated by the gateway and transmitted to the platform that redirected it to the terminal. According to an alternative, it has been generated by the platform that transmitted it to the gateway in its access authorisation validation request.

According to another alternative, it has been generated by the user terminal that transmitted it to the platform in its request to access the local network LAN, which retransmitted it to the gateway in its authorisation validation request.

In 55, it transmits a connection request to the gateway GW comprising the connection information and advantageously the received authorisation token JA.

Once connected, it receives in 56 from the gateway GW a request to select an item of equipment from a plurality of items of equipment it is authorised to access. It responds in 57 and receives in 58 connection information to the item of equipment comprising at least one IP address or one unique identifier of this item of equipment.

It can then connect in 59 to the item of equipment and access its services.

In relation to FIG. 6, the exchanges of messages between the user terminal TU, the management platform PTF and the gateway GW to manage the local network LAN according to a first embodiment of the development are now presented in the form of a flow diagram.

It is assumed here that the user has subscribed to a service for remotely accessing their local network(s) with their operator and that they access it/them via the web or a mobile application they installed on their terminal TU or even a web application. In particular, they have an identifier and a password to connect to an interface or portal of their platform PTF. In 51, they transmit a connection request CNX with this interface, identify and authenticate themselves to the platform using their identifier and password.

In this first example, it is assumed that the interface available to the user on their terminal only allows them to connect to the platform PTF. In other words, it has minimal intelligence and in particular does not know which local communication networks the user is authorised to connect to.

Its request to access a local network is therefore limited to a connection request to the remote access service of the platform and does not specify the desired communication network LAN.

The platform receives and processes the connection request in 30. Once the user terminal is authenticated, it obtains in 31 the access rights associated with the user identifier IDU. For example, it obtains the identifiers of the local communication networks it is authorised to access.

Optionally in 32, it sends it a request to select a local network from a list of local networks it is authorised to access. If it is not authorised to access any local network, it notifies it and terminates the connection.

From these identifiers, it verifies in 33 that the user is authorised to access at least one local communication network LAN.

In 52, the selection request is received by the user terminal TU, that makes its choice and then sends it in 53 to the platform. The platform sends in 35 to the IP address of the gateway GW that manages the selected communication network LAN a wake-up message WOW, for example a “Wake On Wan” wake-up packet. It is transmitted by the remote network WAN to the gateway that receives it in 40 on its interface WAN.

It is assumed in this example that the gateway GW is in a standby state.

In 41, the interface WAN of the gateway GW activates a wake-up constraint management program. This is for example an appointment calendar, and it obtains information relating to time constraints to wake up the gateway for different times of the day or days of the week and it verifies that waking up the gateway and the local network is authorised for the current time period. If this is the case, it wakes up in 42 at least one interface for managing remote access requests to its local network LAN and one communication interface in the local network, such as its Wi-Fi interface. Optionally, it triggers in 43 a mutual authentication with the platform PTF. The exchanges between the gateway and the platform are encrypted. If, on the contrary, the wake-up is not authorised, it rejects the wake-up request and notifies the platform of the rejection of its wake-up request.

After successful mutual authentication, the platform PTF transfers to the gateway in 37 a request to validate an authorisation of the user terminal TU to access the local communication network LAN. This request can comprise connection information to certify that the access request from the terminal TU to the gateway GW has been validated by the platform PTF. This data can be, for example, a simple flag, or an identifier/password pair of the terminal TU or its user. This request DVA can also comprise a temporary access authorisation token JAT generated by the platform PTF or received from the user terminal TU in its request to access DA the network LAN.

Following the authentication, the gateway GW has activated a program to validate the access rights of users. Upon receipt of the validation request DVA from the platform, it validates in 44 the user's rights and sends its validation response in 45 to the platform. This response comprises the validated connection information IA and in particular the access authorisation token JA, that can be identical to the temporary token JAT it received from the platform.

The platform PTF receives the response from the gateway in 38, extracts the connection information and redirects it in 39 to the user terminal.

The user terminal receives in 54 this connection authorisation information from the platform PTF. In 55, it transmits a connection request to the IP address of the gateway, comprising the connection information and advantageously the authorisation token JA. Upon receipt in 46, the gateway verifies this information and in particular the authorisation token JA of the user connection. If it corresponds to the information registered for this user and in particular to the authorisation previously validated with the platform PTF, the gateway GW establishes the connection.

It then offers the user in 47 a choice of equipment/services the user is authorised to access. Examples include the gateway itself, a central alarm station, a personal computer, a stand-alone camera, a network-attached storage NAS, etc. The user receives it in 56 and responds in 57 by selecting an item of equipment/service from those offered by the gateway. It is for example the server NAS. Upon receipt in 48, the gateway wakes up one of its interfaces to communicate with the server NAS and sends it a wake-up message. For example, it activates its Wi-Fi interface and sends it a “Wake On Lan” wake-up packet. As soon as it has woken up, the server NAS activates a welcome program. In particular, it connects to the gateway that redirects the IP address of the server NAS to the user terminal in 48. Upon receipt in 58, the user terminal sends in 59 a connection request to the IP address of the server NAS. Once logged in, it accesses its welcome programme and the services offered.

Once the user terminal has disconnected and the execution of the services it has activated is complete, the gateway GW places back its local network and its own functions in a standby state.

In relation to FIG. 7, the exchanges of messages between the user terminal TU, the management platform PTF and the gateway GW to manage the local network LAN according to a second embodiment of the development are now presented in the form of a flow diagram.

In this second example, it is assumed that the human/machine interface available to the user on their terminal TU for accessing the remote access service to local communication networks is more elaborate than in the example of FIG. 6, and in particular that it allows them to choose from a list of sites the local communication networks accessible at each site. A site refers here to the geographical location of a company or individual's buildings, comprising one or more local communication networks. For example, this interface accesses in a memory to an association between the user identifier IDU and a site identifier, one or more local network identifiers of this site authorised for this user, and for each local network identifier one or more item of equipment/service identifiers. It offers the user in 50 to choose at least the local network or even the item of equipment they are interested in from a menu, but they can also choose an item of equipment of this local network. Once this choice has been made, it triggers the transmission in 51 by the terminal of a request to access RA the chosen local network to the platform PTF. The steps 30-32 of receiving the request and verifying access rights are implemented similarly to the example of FIG. 6. One difference is that the platform specifically verifies that the user terminal has the right to access the local network that the user has explicitly requested.

When the user is authorised, the platform sends in 35 a wake-up message WOW to the gateway that manages the requested access network, as previously described. Steps 35 to 38 implemented by the platform are unchanged, as are steps 40-45 implemented by the gateway.

In 54, the user terminal TU receives the connection information to the gateway that manages the requested access network, as previously described, comprising at least the IP address of the gateway or a unique identifier of this gateway, a connection identifier and a password and optionally the access authorisation token JA. In 55, the application interface on the user terminal side transmits a connection request CNX to the gateway, that comprises not only the connection information ICNX, but also the identifier of the item of equipment EQ the user wants to access. In 46, the gateway verifies that the authorisation token is correct and that the user is authorised to access the requested item of equipment/service. If so, it wakes up the relevant item of equipment EQ in 48, as previously described. The gateway GW then sends an application message to the user terminal comprising connection information to the item of equipment. In 59, the user terminal TU transmits a connection request to the item of equipment EQ comprising the received connection information. Once connected, it accesses the services offered by this item of equipment.

Once the user terminal has disconnected and the execution of the services it has activated is complete, the gateway GW places back its local network and its own functions in a standby state.

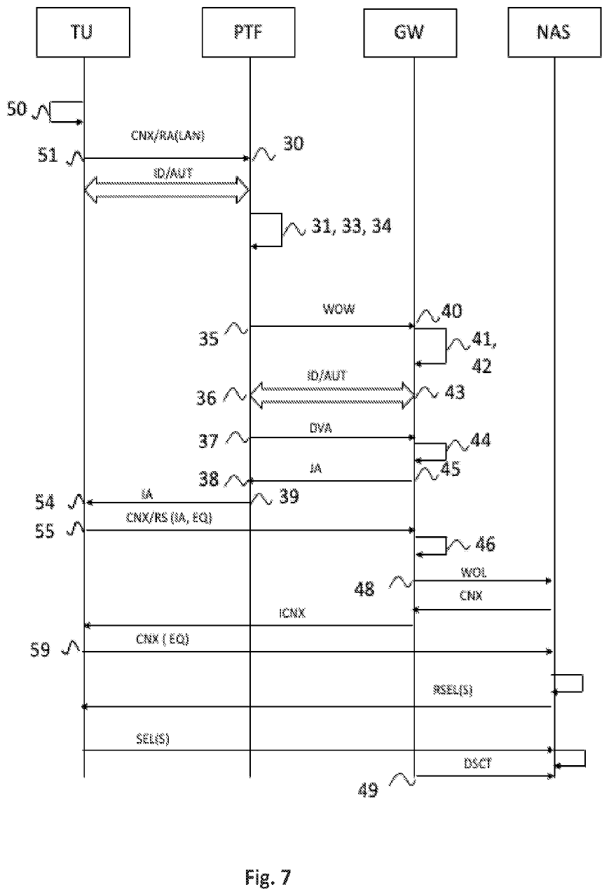

In relation to FIG. 8, another example of the hardware structure of a device 100 for managing a request to remotely access a local communication network according to the development is now presented, comprising, as illustrated by the first example of FIG. 2, at least a module REC. RA for receiving a request to access a local network from the user terminal TU, the request comprising at least one user identifier IDU, a module OBT. DA for obtaining access rights associated with the user identifier, a module VER. AR for verifying an authorisation of the user to access the requested network, a module WOW for waking up the gateway, configured to be implemented when the user is authorised to access the network, a module OBT. JA for obtaining an authorisation validation from the gateway, comprising an access authorisation token, and a module TRNS. JA for transmitting the authorisation token to the user terminal TU.

Advantageously, the device 100 further comprises a module AUTH for authenticating the management platform to the gateway GW. It can also comprise a module RSEL(LAN) for requesting the selection of a local network to the user terminal from a plurality of authorised local networks and a module SEL(LAN) for obtaining the local network selected by the user terminal from the plurality transmitted.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (for example, a RAM memory), a processing unit 102 equipped for example with a processor and controlled by a computer program Pg1, representative of the reception, verification, validation and transmission of connection information modules, stored in a read-only memory 101 (for example, a ROM memory or hard disk). At initialisation, the code instructions of the computer program are for example loaded into a random access memory 103 before being executed by the processor of the processing unit 102. The random access memory 103 can also contain a table comprising an entry associating access rights to local networks with the user identifier.

FIG. 8 only shows a particular one of several possible ways of realising the device 100, so that it executes the steps of the method for managing a request to access a local communication network as detailed above, in relation to FIGS. 3, 6 and 7 in its different embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

The various embodiments have been described above in relation to a device 100 integrated into a management platform PTF connected to the communication network WAN, but it may also be integrated into any other item of equipment connected to the communication network WAN, such as for example a router of the access network, an existing service platform such as a management platform of a customer welcome portal of the network WAN operator.

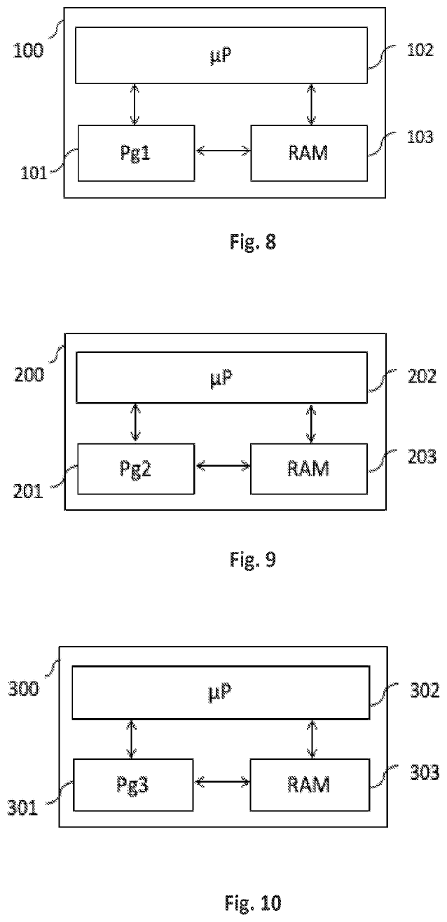

In relation to FIG. 9, a second example of the hardware structure of a device 200 for processing a request to access a local communication network according to the development is now presented, comprising, as illustrated by the example of FIG. 2, at least a module REC. WOW for receiving a wake-up message from the management platform PTF, a module for authorising the wake-up depending on predetermined constraints, a module for validating a request to authorise access to the service from the management platform PTF and transmitting to said management platform an access authorisation token. The device 200 also comprises a module for connecting the user terminal to the service upon receipt of a connection request comprising the access authorisation token.

Advantageously, the device 200 also comprises a module AUTH PTF for authenticating the management platform PTF and a module TRNS DS for transmitting a request to select a service from a plurality of services the user is authorised to access.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200 comprises a random access memory 203 (for example, a RAM memory), a processing unit 202 equipped for example with a processor and controlled by a computer program Pg2, representative of the reception, authorisation validation and connection modules, stored in a read-only memory 201 (for example, a ROM memory or hard disk). At initialisation, the code instructions of the computer program are for example loaded into a random access memory 203 before being executed by the processor of the processing unit 202. The random access memory 203 can also contain a table comprising an entry associating with the user identifier IDU an access right to the local network LAN managed by the gateway and to equipment of this network.

FIG. 9 only shows a particular one of several possible ways of realising the device 200, so that it executes the steps of the processing method as detailed above, in relation to FIGS. 4, 6 and 7 in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200 is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

Finally, in relation to FIG. 10, an example of the hardware structure of a device 300 for requesting access to a local communication network according to the development is presented, comprising, as illustrated by the example of FIG. 2, at least a module TRNS RA for transmitting a request to access a local communication network LAN to the management platform PTF, a module REC. @IP, JA for receiving connection information to the gateway GW comprising an IP address of the gateway and an access authorisation token and a module CNX for requesting a connection to the IP address of the gateway, the connection request comprising the access authorisation token for the network.

Advantageously, the device 300 also comprises a module SEL. S for selecting a local network from a plurality of local networks authorised by the platform for the user terminal.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 300 comprises a random access memory 303 (for example, a RAM memory), a processing unit 302 equipped for example with a processor and controlled by a computer program Pg3, representative of the reception, authorisation validation and connection modules, stored in a read-only memory 301 (for example, a ROM memory or hard disk). At initialisation, the code instructions of the computer program are for example loaded into a random access memory 303 before being executed by the processor of the processing unit 302. The random access memory 303 can also contain a table comprising an entry associating with the user identifier IDU an access right to the local network LAN managed by the gateway and to equipment of this network.

FIG. 10 only shows a particular one of several possible ways of realising the device 300, so that it executes the steps of the access request method as detailed above, in relation to FIGS. 5, 6 and 7 in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 300 is realised with a reprogrammable computing machine, the corresponding program (that is the sequence of instructions) can be stored in a removable (such as, for example, an SD card, a USB flash drive, CD-ROM or DVD-ROM) or non-removable-storage medium, this storage medium being partially or totally readable by a computer or a processor.

The development that has just been described in its different embodiments has many advantages. In particular, it facilitates the task of a user who wants to remotely access a local communication network placed in a standby state, while ensuring the security of the equipment of this network. Indeed, the user always uses the same platform, regardless of the communication network they want to access. This platform stores the access rights of this user to one or more sites and/or local networks. Thus, the platform secures upstream access to the gateway and its local network by allowing only duly identified and authorised requests to pass through. This makes it much more difficult for hackers to gain access to a user's local network when it is in a standby state.

By enabling a simple and secure remote access, the development therefore encourages users to place their equipment in a standby state when they are away, and thus contributes to saving energy resources.

1. A method of managing a request to access a local communication network managed by a gateway to access a remote communication network, wherein the method, implemented by a management platform connected to the remote network, comprises:
receiving the request to access the local communication network from a user terminal connected to the remote communication network, the request comprising at least one user identifier;
verifying that the user is authorized to access the local communication network using the user identifier and access rights stored in a memory; and
if the user is authorized to access the requested local network,
transmitting a wake-up message to the gateway; and
transmitting to the user terminal a response comprising at least one identifier of the gateway.

2. The method of managing a request to access a service according to claim 1, wherein the method comprises transmitting to the user terminal a request to select a local network and in that the transmission of the wake-up message is triggered upon receipt of a response comprising the identifier of the selected local network to the gateway that manages the selected local communication network.

3. The method of managing a request to access a service according to claim 1, wherein the method comprises, following the transmission of the wake-up message, receiving a validation of an authorization to access the service from the gateway and in that the response is transmitted to the user terminal, following the reception.

4. The method of managing a request to access a service according to claim 3, wherein the validation of an access authorization received from the gateway comprises an access authorization token and in that the response transmitted to the user terminal comprises the token.

5. A method of processing a request to remotely access a local communication network managed by a gateway to access a remote network, wherein the method is implemented by the gateway and comprises:
receiving a wake-up message from a management platform connected to the remote network, the platform being configured to receive a request to access a local communication network from a user terminal connected to the remote network and to verify an authorization of the terminal to access the network;
when the gateway is in a standby state, triggering a gateway wake-up operation, and
upon receipt of a request to validate an authorization of a user to access the local network from the management platform, transmitting a response to validate the authorization of the user to access the local network to the management platform; and
upon receipt of a connection request from the user terminal, connecting the user terminal to the local network.

6. The method of processing a request to remotely access a local communication network according to claim 5, wherein the method comprises obtaining a connection authorization token and in that an access authorization validation response comprises the token.

7. The method of processing a request to remotely access a local communication network according to claim 5, wherein the method comprises obtaining wake-up constraints comprising authorized time periods and prohibited time periods and verifying that waking up the gateway is authorized in a current time period.

8. A method of requesting remote access to a local communication network managed by a gateway to access a remote communication network by a user terminal connected to the remote network, wherein the method is implemented by the user terminal and comprises:
transmitting a request to access a local communication network to a management platform connected to the remote network, the request comprising at least one user identifier;
receiving a response from the platform comprising at least one identifier of the gateway; and
transmitting a connection request to the at least one identifier of the gateway.

9. The method of requesting remote access to a local communication network according to claim 8, wherein the response further comprises a connection authorization token to the network and in that the connection request comprises the token.

10. The method of requesting remote access to a local communication request according to claim 8, wherein the method further comprises a selection of a local network from a plurality of authorized local networks, upon receipt of a selection request received from the management platform or the user terminal.

11. A processing circuit comprising a processor and a memory, the memory storing program code instructions of a computer program for executing the method according to claim 1, when the computer program is executed by the processor.

12. A device for managing a request to remotely access a local communication network managed by a gateway to access a remote communication network, wherein the device is configured to implement at a management platform connected to the remote network:
receiving the request to access a local communication network from a user terminal connected to the remote communication network, the request comprising at least one user identifier;
verifying an authorization of a user to access the network using the user identifier and access rights stored in a memory; and
if the user is authorized to access the requested network,
transmitting a wake-up message to the gateway; and
transmitting to the user terminal a response comprising at least one identifier of the gateway.

13. A device for processing a request to remotely access a local communication network managed by a gateway to access a remote network, wherein the device is configured to implement at the gateway:
receiving a wake-up message from a management platform connected to the remote network, the platform being configured to receive a request to access a service operated by the local communication network from a user terminal connected to the remote network and to verify an authorization of the terminal to access the service;
when the gateway is in a standby state, triggering a gateway wake-up operation, and
upon receipt of a user's access rights to the service from the management platform, validating the user's authorization to access the service and transmitting a validation response to the management platform; and
upon receipt of a connection request from the user terminal comprising at least a gateway identifier, connecting the user terminal to the local network.

14. A device for requesting remote access to a local communication network managed by a gateway to access a remote communication network by a user terminal connected to the remote network, wherein the device is configured to implement at the user terminal:
transmitting a request to access a local communication network to a management platform connected to the remote network, the request comprising at least one user identifier;
receiving a response from the platform comprising at least one identifier of the gateway; and
transmitting a connection request to the gateway using the identifier.

15. A platform for managing a request to remotely access a local communication network managed by a gateway to access a remote network, the platform being connected to the remote communication network, wherein the platform comprises the device for managing a request to remotely access the local communication network from a user terminal according to claim 12.

16. A gateway to access a remote network, configured to manage a local communication network, wherein the gateway comprises the device for processing a request to remotely access the local communication network(L according to claim 13.

17. A user terminal connected to a remote communication network, wherein the user terminal comprises the device for requesting remote access to a local communication network managed by a gateway to access the remote network according to claim 14.

18. A system for managing remote access to a local communication network managed by a gateway to access a remote network, wherein the system comprises, connected to the remote network, the gateway according to claim 16,
a management platform for managing a request to remotely access the local communication network managed by the gateway to access a remote network, the platform being connected to the remote communication network, wherein the platform comprises a first device for managing a request to remotely access the local communication network from a user terminal, wherein the first device is configured to implement at the management platform:
receiving the request to access the local communication network from the user terminal connected to the remote communication network, the request comprising at least one user identifier;
verifying an authorization of a user to access the network using the user identifier and access rights stored in a memory;
if the user is authorized to access the requested network,
transmitting a wake-up message to the gateway; and
transmitting to the user terminal a response comprising at least one identifier of the gateway;
and
the user terminal, wherein the user terminal comprises a second device for requesting remote access to the local communication network managed by the gateway to access the remote network by the user terminal connected to the remote network, wherein the second device is configured to implement at the user terminal:
transmitting a request to access the local communication network to the management platform connected to the remote network, the request comprising at least one user identifier;
receiving a response from the platform comprising at least one identifier of the gateway; and
transmitting a connection request to the gateway using the identifier.
